(19) United States
(12) Patent Application Publication
(10) Pub. No.: US 2004/0010464 A1
(43) Pub. Date: Jan. 15, 2004

(54) Communication device and method for implementing communication on a wide area network

(76) Inventor: John Boaz, McKinney, TX (US)

Correspondence Address: Rudolph J. Buchel, Jr., Jones, Day, Reavis & Pogue, P.O. Box 660623, Dallas, TX, 75266-0623, US

(21) Appl. No.: 10/215,797

(22) Filed: Aug. 9, 2002

Related U.S. Application Data
(60) Provisional application No. 60/395,225, filed on Jul. 11, 2002.

(51) Int. Cl. G06F 17/60

(52) U.S. Cl. 705/40

(57) ABSTRACT

A special purpose VideoPhone terminal combines a desk, telephone and display in a non-threatening manner. The desk may accommodate users may may be confined to a wheelchair or need extra leg room. The telephone is, or either is disguised as a less-menacing-looking telephone. The VideoPhone terminal provides a local participant with a near real-time motion image of the remote participant on what appears to be a television screen but is actually a touch screen. The local user interacts with the VideoPhone system using the touch-tone buttons on the telephone and/or by actuating predefined hotspots on television-like screen. Additionally, the screen is subdivided into separate frames for still and motion images when in use as a videophone. Frames around the real-time motion and/or still images are also active hotspots which control video attributes of the image displayed or to be displayed within the frame and act as a printing control for printing the image. In addition, the telephone rotor or touch-tone buttons may be used to interact with the VideoPhone system. The present invention also incorporates an onboard scheduler application for arbitrating usage between participants and a billing application for billing for Videophone service.

### CROSS REFERENCES TO RELATED APPLICATIONS

The present application is related to and claims priority from U.S. Provisional Patent Application No. 60/395,225, titled “Communication Device And Method For Implementing Communication On A Wide Area Network” and filed on Jul. 11, 2002. The above identified application is incorporated by reference herein in its entirety.

### BACKGROUND OF THE INVENTION

1. Field of the Invention

The present invention relates generally to telecommunications and more particularly to a system, method, computer program product and method of doing business directed to video teleconferencing between a network computer and a care facility.

2. Description of Related Art

Communicating with loved ones is usually as simple as scheduling personal, face-to-face encounters at a convenient location. However, as the nucleus family propagates into separate generational branches, the prodigy often relocate from the familial home making face-to-face scheduling contact with loved ones less convenient because of time and distance constraints. Obviously, face-to-face contact can be supplemented or replaced by written correspondence, hard copy letters, electronic e-mail or electronic messaging, or by telephonic communication, either audio or audio/video telecommunication.

Mailing a letter to a loved one has become a rather one-way communications medium because the respondent will often let many letters go unanswered before finally eliciting a response from the recipient. More often, the recipient is too busy to take the time to pen a return letter. In today's society, correspondence is largely carried on via an electronic medium, such as electronic voice or data mediums. It seems that for no reason other than the electronic medium being more convenient to use, people will more readily respond to an electronic message rather than a posted message, if they respond at all.

Moreover, until the advent of telephone “caller ID,” a caller could reasonably expect an immediate response from a loved one by merely placing a telephone call to the loved one's telephone over a traditional voice network, such as a public switched telephone network (PSTN, a collection of interconnected voice-oriented public telephone networks, both commercial and government-owned, also referred to as the Plain Old Telephone Service (POTS)). Unlike written correspondence, in most cases the PSTN makes a real-time connection between the caller's telephone and the telephone of the called, necessitating an immediate response from the call recipient in real-time. Normally, a recipient must respond to every call to ensure that an important call is not missed. Cellular telephones carry out a similar function but have the advantage of being mobile to allow the caller to reach a loved one at virtually any location in the loved one's calling area. However, cellular telephone have two distinct disadvantages: they are expensive to operate; and because they are relatively current technology, cellular telephones often come equipped with options such as caller ID, voice mail and user preferences that allow a user to screen and decline acceptance of certain telephone calls.

Recently, the Internet has provided an inexpensive mechanism for the near real-time data delivery that is for both messaging and voice communications. E-mail messages may be sent between correspondents and near real-time data communication is possible by using instant messaging services. Instant messaging (sometimes called IM or IMing) is the ability to recognize whether a chosen friend or loved one is connected to the Internet and, if they are, to exchange messages in real-time. Instant messaging differs from ordinary e-mail in the immediacy of the message exchange and also makes a continued exchange more simple than sending e-mails back and forth. Instant messaging services include services such as AOL's Instant Messenger or Yahoo! Messenger.

Internet telephony and VoIP (voice over IP—that is, voice delivered using the Internet Protocol) enables the delivery of voice information using the Internet Protocol (IP). In general, voice information is converted to digital form and then packaged in discrete packets rather than using the traditional circuit-committed protocols of the PSTN. A major advantage of VoIP is that normal long distance toll charges are circumvented, unlike ordinary PSTN telephone service. In relation to the Internet, the PSTN actually furnishes much of the Internet's long-distance infrastructure. Because Internet service providers (ISPs) pay the long-distance providers for access to their infrastructure and share the circuits among many users through packet-switching, Internet users avoid having to pay usage tolls to anyone other than their ISPs.

Consequently, by utilizing the Internet for telephony, a user could achieve near real-time performance while avoiding the expenses normally associated with long distance telephone service when communicating with loved ones. However, the utilization of the Internet for messaging and voice communications has two distinct drawbacks: both the sender and receiver must have the proper equipment to access the Internet and process data packages; and the users must be relatively proficient with the equipment and software tools. While each of these drawbacks is limiting, the Internet has enabled a significant increase in personal communication.

Neither voice or data communication medium have the impact of a face-to-face meeting because, as well understood, human beings are visual creatures and the image of a loved one during interactive correspondence is particularly desirable. In fact, most people desire a high degree of interaction in the correspondence with loved ones which explains the success of Internet based communications applications over traditional mail. However, neither the mail nor PSTN telephone service provides an adequate mechanism for real-time transmission of images adequate for mimicking face-to-face communications. Accordingly, Internet data transmission protocols have been adapted for near real-time image transmission to supplement voice-over-IP capabilities. Current Internet data transmission protocols are based on the H.323 standard approved by the International Telecommunication Union (ITU). The H.323 standard promotes compatibility in videoconference transmissions over IP networks and provides consistency in audio, video and data packet transmissions in the event that a local area network (LAN) did not provide guaranteed service quality (QoS). H.323 is now considered to be the standard for interoperability in audio, video and data transmissions as well as Internet phone and voice-over-IP (VoIP) because it addresses call control and management for both point-to-point and multipoint conferences and gateway administration of media traffic, bandwidth and user participation. Essentially, a personal computer (PC) is easily upgraded to talk face-to-face over the Internet using a webcam (sometimes referred to as a netcam) and the applicable application software. Exemplary webcams include the QuickCam Pro 30Bit, a trademark of and available from Logitech, Fremont, Calif., and Philips Vesta Fun USB PC available from Koninklijke Philips Elec., Amsterdam, Netherlands, each of which have a maximum capture resolution of 640×480 dpi, still digital image capture speeds up to 30 images per second and support still image formats of: JPEG (Joint Photographic Experts Group); BMP (Basic Multilingual Plane); TIFF (Tagged Image File Format); pcx (a filename extension for images created with the IBM PC Paintbrush tool); PNG (Portable Network Graphics); and TGA (Targa Graphics Adaptor). Other image formats include AVI (Audio Video Interleave, designed by Microsoft, Inc.) and MPEG-4 (Moving Picture Experts Group 4 is the fourth in a series of motion picture standards with special application for low bandwidth video telephony and multimedia on the Internet) which are especially useful for transmitting moving images for the Internet.

Videoconference transmissions over IP networks is made possible by a variety of software applications including NetMeeting, a trademark of and available from Internet Explorer from Microsoft Corporation in Redmond, Wash., and CuSeeME a trademark of and available from First Virtual Communications in Santa Clara, Calif. In general, videoconferencing applications should have collaborative point-to-point telephony and VideoPhone capability over the Internet, but support for multipoint whiteboard and application sharing is desirable for use in commercial environments.

However, the utilization of the Internet for face-to-face videoconferencing suffers, in a greater degree, to the two drawbacks described above. Both the sender and receiver must have the proper equipment to access the Internet and process audio/video data packages, and the users must be relatively proficient with the equipment and software tools. Moreover, videoconferencing is subject to the added burden of having to master peripheral video equipment and more complicated application software.

### BRIEF SUMMARY OF THE INVENTION

The present invention enables participants to engage in face-to-face videophoning for a user who is not familiar with personal computers or videoconference equipment and may be intimidated by their usage. A special purpose VideoPhone terminal provides the user with a familiar, unobtrusive and non-threatening terminal by combining a desk, telephone and display. The desk may accommodate users who may be confined to a wheelchair or need extra leg room. The telephone is, or either is disguised as a less-menacing-looking telephone. The VideoPhone terminal provides a local participant with a near a real-time motion image of the remote participant on what appears to be a television screen but is actually a touch screen. The local user interacts with the VideoPhone system using the touch-tone buttons on the telephone and/or by actuating predefined hotspots on a television-like screen. Additionally, the screen is subdivided into separate frames for still and motion images when in use as a videophone. Frames around the real-time motion and/or still images are also active hotspots which control video attributes of the image displayed or to be displayed within the frame and act as a printing control for printing the image. In addition, the telephone rotor or touch-tone buttons may be used to interact with the VideoPhone system.

The present invention also incorporates an onboard scheduler application for arbitrating usage between participants making it uniquely suited for use in facilities with limited financial resources and/or telecommunication access or bandwidth. The scheduler application runs beneath the videophone functionally whereby it can be displayed by any user any time the videophone services are not in use. VideoPhone sessions may be requested by a local user who checks for conflicting sessions reservation at a particular time period and directly logs the requested session into a schedule at the requested time period by interacting with the scheduler. Remote users may request a VideoPhone session directly through the facility managing the VideoPhone terminal using an HTML request document available on the facility's home page or at a site designated for authorized users. Additionally, a billing application is linked to the scheduler and the VideoPhone for billing the Videophone service.

### BRIEF DESCRIPTION OF THE DRAWINGS

The novel features believed characteristic of the invention are set forth in the appended claims. The invention itself, however, as well as an exemplary mode of use, further objectives and advantages thereof, will best be understood by reference to the following detailed description of an illustrative embodiment when read in conjunction with the accompanying drawings, wherein:

The present invention is illustrated by way of example, and not by way of limitation, in the figures of the accompanying drawings and in which like reference numerals indicate similar elements and in which:

FIG. 1 is a diagram of a distributed data processing system in which the present invention may be implemented;

FIG. 2 is a block diagram illustrating a data processing system in which the present invention may be implemented;

FIG. 3 is a diagram illustrating the layered structure of the applications used for implementing the present invention;

FIG. 4 illustrates a process for videophone session handling in accordance with an exemplary embodiment of the present invention;

FIG. 5 illustrates a process for establishing a videophone session where one of the terminals is a special purpose VideoPhone terminal in accordance with an exemplary embodiment of the present invention;

FIG. 6 is a flowchart depicting a billing process implemented by the billing application in accordance with an exemplary embodiment of the present invention;

FIG. 7 is a flowchart of a process implemented by the device application for processing user interactions in accordance with an exemplary embodiment of the present invention;

FIGS. 8A-8C are top and front views of a special purpose VideoPhone terminal in accordance with an exemplary embodiment of the present invention;

FIG. 9 is a diagram of a screen display when a session is not active in accordance with an exemplary embodiment of the present invention; and

FIGS. 10A-10C are diagrams depicting a page flipping sequence implemented by the device application in accordance with an exemplary embodiment of the present invention.

### DETAILED DESCRIPTION OF THE INVENTION

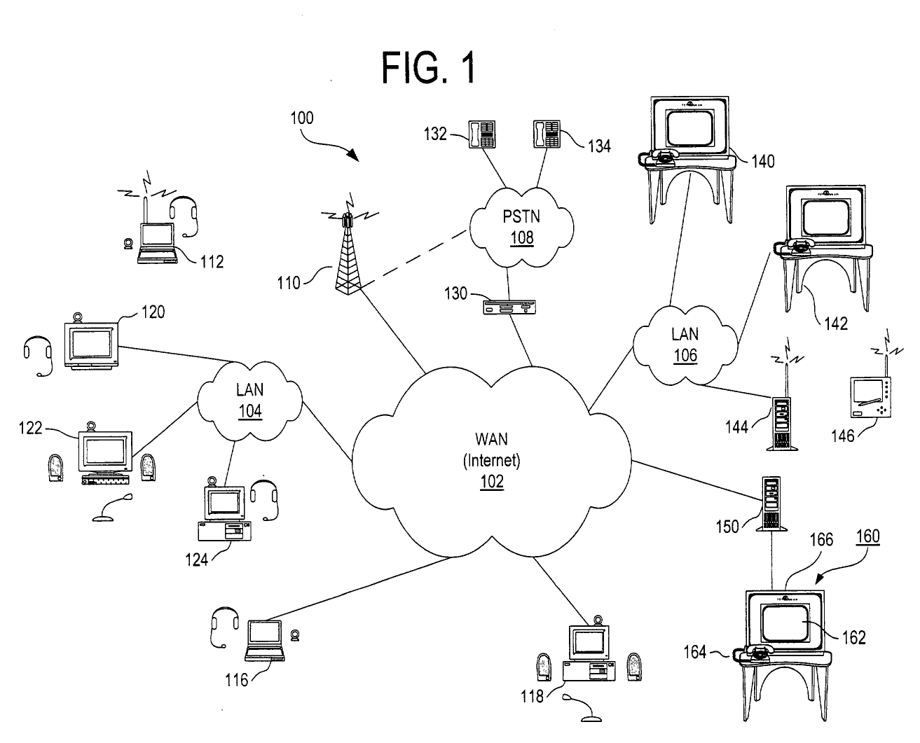

FIG. 1 is a diagram of a distributed data processing system in which the present invention may be implemented. Distributed data processing system 100 is a network of computers and other network equipment in which the present invention may be implemented. Distributed data processing system 100 contains a network 102, which is the medium used to provide communications links between various devices and computers connected together within distributed data processing system 100. Distributed data processing system 100 may include permanent connections, such as wire or fiber optic cables (described more below), or temporary over air connections made through telephone wireless connections (using wireless telecom standards such as Advanced Mobile Phone Service (AMPS), Global System for Mobile Communications (GSM), Time Division Multiple Access (TDMA) and Code Division Multiple Access (CDMA), CDMA 2000 (uses G3 technology for increasing data transmission rates for existing CDMA), wireless LANs (using Proxim's OpenAir and IEEE 802.11 standards) or wireless personal area network (PAN) (using 802.11, WPAN, Bluetooth, HomeRF, HIPERLAN, IrDA Blackberry wireless standards). In the depicted example, distributed data processing system 100 may be the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 may also be implemented as a number of different types of networks, such as, for example, an intranet, Local Area Network (LAN), or Wide Area Network (WAN).

In the depicted example, LANs 104 and 106 are connected to network 102 via any necessary boundary routers or gateways (not shown) along with public switched telephone network (PSTN) 108 via gateway 130 (which converts Internet Protocol (IP) packets to a common-channel signaling system such as Signaling System No. 7 (SS7)). Additionally, cellular network 110 may be connected directly to network 102 via a cellular/IP gateway (not shown) or might be routed instead through PSTN 108. Clients 116, 118 and 150 may also be connected directly to network 102. These clients 116, 118 and 150 may be, for example, personal computers or network computers. For purposes of this application, a network computer is any computer coupled to a network which receives a program or other application from another computer coupled to the network, but should have both audio and video transmission capabilities. In the depicted example, a server internal to network server 102 provides data, such as boot files, operating system images, and applications to clients 116, 118 and 150. Thus, clients 116, 118 and 150 are clients to an internal server to network 102. Distributed data processing system 100 may include additional servers, clients, and other devices not shown.

In a similar fashion, clients 120, 122 and 124 are clients of an internal server of LAN 104 and clients 140 and 142 are clients of an internal server of LAN 106. Notice, however, in the depicted example that server 144 provides a wireless base hub for wireless LAN or PAN clients such as wireless PDA 146. Here it should be understood that for PDA 146 to function within the full intended scope of the present invention, PDA 146 should be equipped with wireless audio and video bi-directional transmission capabilities. Likewise, telephones 132 and 134 connected to PSTN 108 should also have the capability to transmit and receive audio and video.

Finally, some clients are special purpose VideoPhone terminals which are intended to provide users having little or no experience with contemporary VideoPhone technology, with a means to engage in videophoning. One type of special purpose VideoPhone terminal is an eyeOnmom VideoPhone available from eyeOnmom, Inc. in Dallas, Tex. Terminal 160 is depicted as a stand-alone special purpose VideoPhone terminal connected to network 102 via client data processing system 150. Special purpose VideoPhone terminal 160 includes several features which are novel for implementing the present system in a care facility such as a hospital or extended-care facility for the elderly and infirmed. However, eyeOnmom terminal 160 also includes video camera 166 and screen 162 for capturing special purpose VideoPhone and transmitting video images, and receiving and viewing other images, as well as telephone 164 for capturing and listening to audio transmissions. Notice also that the special purpose VideoPhone terminal need not be configured as a stand-alone terminal, but may instead be configured as a net computer where the support functions normally provided by client data processing system 150 are provided by an application server within a connected LAN or WAN. For example, clients 140 and 142 are also special purpose VideoPhone terminals, but rather than being supported by separate data processing systems, the bulk of the support is provided by a remote server within LAN 106. One of ordinary skill in the art would readily realize that most net computers require lightweight processing support and minimal memory, so nominal client processing is still required locally. FIG. 1 is intended as an example and not as an architectural limitation for the present invention.

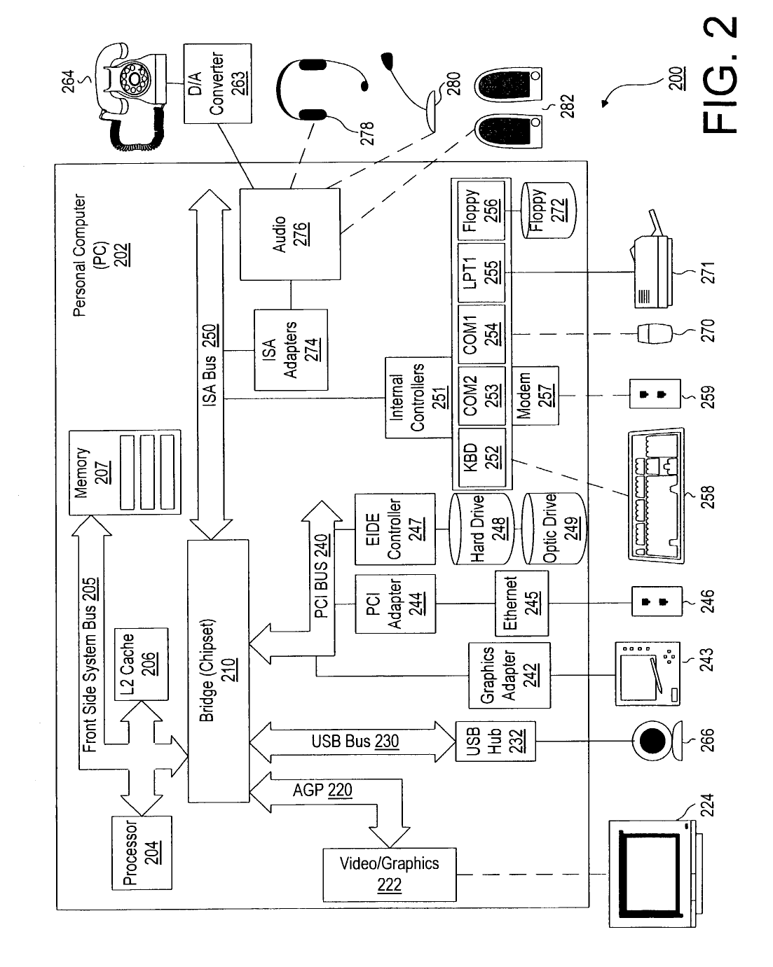

FIG. 2 is a block diagram illustrating a data processing system in which the present invention may be implemented. Peripheral equipment connected to data processing system 200 is depicted by solid lines in an exemplary embodiment of the present invention, while those connected by dash lines depict alternative exemplary embodiments. Data processing system 200 is an example of client computer 202 and the associated peripheral equipment needed to practice the present invention. Data processing system 200 employs a bridging-type architecture using bridge chipset 210 peripheral for simultaneously connecting to a plurality of different types of local bus architectures. With respect to the depicted example, these local bus types include Accelerated Graphics Port (AGP), Universal Serial Bus (USB), Peripheral Component Interconnect (PCI) and Industry Standard Architecture (ISA), in the future, although many other standard bus architectures are known and will be developed that could be used to support the present invention.

Processor 204 connects to front side system bus 205, which allows processor 204 to communicate with main memory 207 (usually random access memory (RAM)), chipset 210, and L2 cache 206. Ideally, processor 204 is specifically designed for multimedia data transfer such as a 1.8 GHz Intel® Pentium 4 processor which uses a 400 MHz system bus (front side bus 205) and is available from Intel Corporation in Santa Clara, Calif. which uses a 400 MHz system bus (front side bus 205). Bridge 210 may also include an integrated memory controller and cache memory for processor 204. Additional connections to any of the buses depicted may be made through direct component interconnection or through add-in boards. In the depicted example, AGP bus 220 provides a communications link between processor 204, memory 207 and video/graphics card 222 which, in turn, supports any one of a variety of types of monitors 224. A conventional video monitor may be used for practicing the present invention or in accordance with other embodiments; a touch screen display is used for both displaying video images and receiving user interaction input. Also needed for the present invention is a means for capturing real-time video images such as video camera 266 which is shown connected to USB bus 230 through multi-port USB hub 232. Video camera 266 is often referred to as a net- or web-camera (shortened to webcam or netcam) because it is specifically designed to be used with network applications. It should be understood that, while the present example depicts video camera 266 as a USB type camera, the USB bus is considered to have a relatively low data transfer rate. Low data transfer rates lessen the amount of video pixel data that can be transferred for a given time period. Low data transfer rates are normally accommodated in one of four ways: smaller image frame; lower image frame rate; lower image resolution; and lower color resolution. These techniques can be used independently, or several techniques may be combined to accommodate narrower bandwidth constraints. However, each of these methods detracts from the user's overall enjoyment and appreciation of the image, and therefore, they should be used sparingly or avoided if adequate bandwidth permits. Therefore, while in the present example video camera 266 is depicted as a USP camera, others types of video cameras are known which generally achieve higher data transfer rates. These may be connected to either Industry Standard Architecture (ISA) bus 250 or Perpipheral Component Interconnect (PCI) bus 240. ISA bus 250 is generally used for slower devices, while PCI bus 240 connects the fast devices to the CPU. ISA is an older, lower capacity type of bus and may not be present in all data processing systems. Thus, PC bus 240 is the logical choice for higher data transfer rates. Below is a table listing the data transfer attributes for several popular types of local bus architectures.

TABLE I
(Local Bus Attributes)

| Bus Type | Width | Speed | Total Rate |
|---|---|---|---|
| ISA | 16 bits | 8 MHz | 16 MB/sec |
| EISA | 32 bits | 8 MHz | 32 MB/sec |
| VL-bus | 32 bits | 25 MHz | 100 MB/sec |
| VL-bus | 32 bits | 33 MHz | 132 MB/sec |
| PCI | 32 bits | 33 MHz | 132 MB/sec |
| PCI | 64 bits | 33 MHz | 264 MB/sec |

Touch screen display 243 is depicted as being connected to graphics adapter 242, which may be connected to PCI bus 240 by an add-in board inserted into an expansion slot, thus allowing touch screen display 243 to communicate with processor 204. Typical PCI local bus implementations support three or four PCI expansion slots or add-in connectors. Using touch screen 243, a user can view images, both still and motion, while simultaneously interacting (issuing commands) with data processing system 200. Often a touch screen uses beams of infrared light that are projected across the screen surface which generate an electronic signal identifying the location of the screen when interrupted by the user.

By contrast, other types of audio adapters, graphics adapters, and audio/video adapters may be connected to PCI bus 240 by add-in expansion slots provided by a PCI adapter, such as PCI adapter 241. Essentially, a PCI adapter provides two functions: a physical connection means for attaching peripherals to the PCI bus; and logical support necessary for communicating with the peripheral device itself. With respect to the depicted example, PCI adapter 241 is connected to Ethernet controller 244 which provides a communications link between network 102 and data processing system 200 through Ethernet connection 245. Standard Ethernet systems are called 10BASE-T and support data transfer rates up to 10 megabits per second (10 Mps), but Fast Ethernet or 100BASE-T provides transmission speeds up to 100 Mps. Typically, Fast Ethernet is reserved for LAN backbone systems, supporting data processing systems with 10BASE-T Ethernet connections. Often, a PCI adapter will contain the logical and physical Ethernet support for both 10BASE-T and 100BASE-T without a separate Ethernet controller.

Normally, the choke point for limiting the practice of the present invention is the communications bandwidth. Therefore, it should be understood that accessing the maximum possible bandwidth will facilitate the practice of the present invention). Assuming the location is close enough to a telephone company central office that offers Digital Subscriber Line (DSL) service, a user may be able to receive data at rates up to 6.1 megabits (millions of bits) per second (of a theoretical 8.448 megabits per second), enabling continuous transmission of motion video, audio, and even 3-D effects. More typically, individual connections will provide from 1.544 Mbps to 512 Kbps downstream and about 128 Kbps upstream. Below in Table II are attributes for the various types of DSL. Table III are attributes for the various types of T-carriers. It should be understood that T-carrier services are extremely expensive and are usually leased between two or more fixed locations. Thus, while T-carrier service offers extremely generous bandwidth capacities, it is generally neither flexible enough for use with the present invention nor is it cost effective.

TABLE II
(DSL Attributes)

| | | Data Rate | | |
|---|---|---|---|---|
| DSL | Des- | Downstream; | Distance | |
| Type | cription | Upstream | Limit | Application |
| IDSL | ISDN | 128 Kbps | 18,000 feet | Similar to |
| | Digital | | on 24 gauge | the ISDN BRI |
| | Subscriber | | wire | service but |
| | Line | | | data only |
| | | | | (no voice on |
| | | | | the same line) |
| CDSL | Consumer | 1 Mbps | 18,000 feet | Splitterless |
| | DSL from | downstream; | on 24 gauge | home and small |
| | Rockwell | less | wire | business |
| | | upstream | | service; similar |
| | | | | DSL Lite |
| DSL | “Splitter- | From 1.544 Mbps | 18,000 feet | The standard |
| Lite | less” DSL | to 6 Mbps | on 24 gauge | ADSL; sacrifices |
| (same | without | downstream, | wire | speed for not |
| as G. | the “truck | depending on the | | having to install |
| Lite) | roll” | subscribed service | | a splitter at the |
| | | | | user's home or |
| | | | | business |
| G. Lite | “Splitter- | From 1.544 Mbps | 18,000 feet | The standard |
| (same | less” DSL | to 6 Mbps, | on 24 gauge | ADSL; sacrifices |
| as DSL | without | depending on the | wire | speed for not |
| Lite) | the “truck | subscribed service | | having to install |
| | roll” | | | a splitter at the |
| | | | | user's home or |
| | | | | business |
| HDSL | High bit- | 1.544 Mbps | 12,000 feet | T1/E1 service |
| | rate | duplex on two | on 24 gauge | between server |
| | Digital | twisted-pair | wire | and phone |
| | Subscriber | lines; 2.048 Mbps | | company or |
| | Line | duplex on three | | within a com- |
| | | twisted-pair lines | | pany; WAN, |
| | | | | LAN, server |
| | | | | access |
| SDSL | Symmetric | 1.544 Mbps | 12,000 feet | Same as for |
| | DSL | duplex (U.S. and | on 24 gauge | HDSL but re- |
| | | Canada); 2.048 | wire | quiring only |
| | | Mbps (Europe) on | | one line of |
| | | a single duplex | | twisted-pair |
| | | line downstream | | |
| | | and upstream | | |
| ADSL | Asym- | 1.544 to 6.1 | 1.544 Mbps | Used for Internet |
| | metric | Mbps down- | at 18,000 | and Web access, |
| | Digital | stream; 16 to 640 | feet; | motion video, |
| | Subscriber | Kbps upstream | 2.048 Mbps | video on demand, |
| | Line | | at 16,000 | remote LAN |
| | | | feet; | access |
| | | | 6.312 Mpbs | |
| | | | at 12,000 | |
| | | | feet; | |
| | | | 8.448 Mbps | |
| | | | at 9,000 feet | |
| RADSL | Rate- | Adapted to the | Not provided | Similar to ADSL |
| | Adaptive | line, 640 Kbps | | |
| | DSL from | to 2.2 Mbps | | |
| | Westell | downstream; 272 | | |
| | | Kbps to 1.088 | | |
| | | Mbps upstream | | |
| UDSL | Uni- | Not known | Not known | Similar to HDSL |
| | directional | | | |
| | DSL | | | |
| | proposed | | | |
| | by a | | | |
| | company | | | |
| | in Europe | | | |
| VDSL | Very high | 12.9 to 52.8 | 4,500 feet at | ATM networks; |
| | Digital | Mbps down- | 12.96 Mbps; | Fiber to the |
| | Subscriber | stream; 1.5 to | 3,000 feet at | Neighborhood |
| | Line | 2.3 Mbps up- | 25.82 Mbps; | |
| | | stream; | 1,000 feet at | |
| | | 1.6 Mbps to 2.3 | 51.84 Mbps | |
| | | Mbps down- | | |
| | | stream | | |

TABLE III
(T-Carrier Attributes)

| T-Carrier | Total Speed | | Channels |
|---|---|---|---|
| T1 | 1.544 | Mbps | 24 |
| T2 | 6.312 | Mbps | 96 |
| T3 | 44.736 | Mbps | 672 |

Hard drive 248 connects to PCI bus 240 through Enhanced Integrated Drive Electronics (EIDE) controller 241 which extends the Advanced Technology Attachment (ATA) interface while maintaining compatibility with PC (Basic Input/Output System) BIOS designs. CD-ROM drive 249 is also controlled by EIDE controller 241, which might control any type of optical ROM drive including DVD-ROM or CD/RW. Hard drive 248 stores any information that cannot be held elsewhere in data processing system 200, including executable applications, configuration data and images, libraries and data. An additional expansion PCI bus interface may be provided for a connection to a keyboard and mouse adapter, modem, and additional memory or alternative keyboard 258, mouse 270 and modem 259 may be handled by external controllers 251 connected to ISA bus 250.

Many data processing systems are pre-configured with internal adaptions for certain peripherals that are most often needed, i.e. keyboard, mouse, modem printer and disk drive. With respect to the depicted example, keyboard 258 is controlled by internal keyboard controller 252, while mouse 259, which communicates by using a serial (bit-stream) protocol, is connected to serial line port COM 1245. Alternatively, mouse 270 may also be controlled by internal keyboard controller 252. Disk drive 272 accepts data diskettes and is controlled by floppy controller 256. Depending on the system, all memory drives may be controlled by the same controller, such as by EIDE controller 246.

An additional means for communication between network 102 and data processing system 200 through telephone connection 259 is by means of modem 257. Modem 257 converts analog telephonic signals into digital signals which are able to be understood by data processing system 200. However, modems generally limit data transfer rates to less than 56 kilobits per second (56 Kbs), but in practice, telecommunications network constraints limit the transmission speeds to less than 52 Kbs. Therefore, although it is possible to implement the present invention using a modem for the bi-directional transfer of audio/video data, it is not practical due to the narrow bandwidth constraints (see Table II and Table III above). Hard disk drive 248, floppy drive 256, CD-ROM drive 249, printer 271, scanners, tape drives and other intelligent devices may be connected alternatively through a Small Computer System Interface (SCSI) host bus adapter. SCSI is the most popular processor-independent standard, via a parallel bus, for system-level interfacing between a computer and intelligent devices. SCSI can connect multiple devices to a single SCSI adaptor (or “host adaptor”) on the computer's bus and transfers bits in parallel while operating in either asynchronous or synchronous mode.

Printer 271 is connected to ISA bus 250 using parallel port LPT1 255 which provides an interface from a computer system where data is transferred in or out in parallel, that is, on more than one wire. Printer 271 should be capable of high resolution color printing of near photo quality images. Scanners may also be connected to LPT1 255, although more recent scanners are also USB enabled.

PC 202 also has audio capability over ISA Bus 250 using ISA adapters 274 which allow for audio card 276 to be plugged in. Alternatively, audio card 276 might be plugged directly into ISA bus 250. Audio data may be delivered to the user through speakers 282, headset 278 or to standard analog telephone 264 through digital to analog (D/A) converted 263. Additionally, audio may be received from the user through microphone 280, headset 278 or telephone 264 using D/A converted 263. In accordance with one exemplary embodiment of the present invention, a special purpose VideoPhone terminal for a care facility comprises PC 202, standard analogy telephone 264, and touch screen display 243 for bi-directional and real-time video and audio through the Internet.

An operating system runs on processor 204 and is used to coordinate and provide control of various components within data processing system 200 in FIG. 2. The operating system may be a commercially available operating system such as a UNIX based operating system, AIX for instance, which is available from International Business Machines Corporation. “AIX” is a trademark of International Business Machines Corporation. Other operating systems include OS/2. An object-oriented programming system, such as Java, may run in conjunction with the operating system and provide calls to the operating system from Java programs or applications executing on data processing system 200. “Java” is a trademark of Sun Microsystems, Inc. Instructions for the operating system, the object-oriented operating system, and applications or programs are located on storage devices, such as hard disk drive 248, and may be loaded into main memory 207 for execution by processor 204.

Those of ordinary skill in the art will appreciate that the hardware in FIG. 2 may vary depending on the implementation. Other internal hardware or peripheral devices, such as flash ROM (or equivalent non-volatile memory) or optical disk drives and the like, may be used in addition to or in place of the hardware depicted in FIG. 2. Also, the processes of the present invention may be applied to a multiprocessor data processing system.

Optionally, one of ordinary skill in the art would readily recognize that components identified above as hardware by their designation as “circuitry,” boards,” “cards,” or the like, may also be embodied as software, firmware or some combination depending on the intended implementation and usage. Neither the depicted example in FIG. 2 nor the above-described examples are meant to imply architectural limitations.

The present invention is directed to a system and method for efficiently utilizing the Internet for face-to-face videophoning when one or both participants in the conference are not proficient in the use of personal computers and/or other teleconferencing equipment. Additionally, the present invention is particularly suited for providing face-to-face videoconferencing in environments where bandwidth and equipment constraints limit accessibility to users. Moreover, the present invention is extremely cost effective as the majority of the infrastructure takes advantage of the shelf hardware and software components.

Accordingly, face-to-face videoconferencing is possible even though one or both parties are not familiar with personal computers or videoconference equipment by arranging a VideoPhone terminal as more recognizable equipment, of which the user is more familiar and able to make use of more easily. In accordance with an exemplary embodiment of the present invention, the user talks and listens to a remote participant on a standard telephone. Additionally, the user views a real-time motion image of a remote participant on what appears to be a television screen. Commands are issued by the user to the VideoPhone terminal in one of two primary means through touch-tone buttons on the telephone and/or through predefined hotspots on the television screen. The system recognizes and processes the Dual-Tone Multi-Frequency (DTMF) signals from the telephone in much the same manner as a public exchange telecommunications carrier. Thus, a user may enter private information such as a user-ID or PIN for scheduling or accepting a videoconference. Additionally, a predefined hotspot on the television-like touch screen reacts to a user's touch to perform associated tasks in accordance with user selections.

One task involves scheduling a videoconference. It is expected that whenever the VideoPhone terminal is not in use, the screen will display a listing of upcoming VideoPhone sessions. Once a user's name appears on the schedule, the user can confirm that the scheduled conference is convenient by merely touching the name on the screen and entering the user PIN (either on the touch screen or using the touch-tone telephone). Once a user's PIN is entered, the videoconference can be provisioned by the scheduling and billing applications. In accordance with another exemplary embodiment of the present invention, an icon will appear on the screen when a participant has set up the VideoPhone session and is waiting for the user to join the VideoPhone session, i.e. a telephone or some other familiar icon. The user joins an ongoing session by merely touching the icon on the touch screen.

Another task involves printing a screen image. In accordance with another exemplary embodiment, the screen of the touch panel is subdivided into several image frames, such as one frame for a real-time motion image of the remote participant and one or more frames of still images transmitted by the remote participant. For instance, a remote participant may electronically transmit pictures (images) of a family member for the local user to view during the VideoPhone session. At any point during the session, the user can create a hard copy image of either the remote participant or a still image in any other frame by merely touching a hot spot associated with the desired image. Additionally, if more pictures have been sent, those can be displayed on the screen at one time so the user may flip through images sent by the remote participant by merely touching another hotspot associated with the displayed still images. For example, a user wishing to print a picture of the remote participant issues a print command to the video conference system by touching the image of the participant on the touch screen. In another example, if a user wishes to print a picture of one of the still pictures transmitted by the remote participant, the user merely touches the image of the still picture of the a print that is desired.

Another task involves scanning or flipping through a group of pictures. In accordance with another exemplary embodiment, sufficient memory is provided in the videoconference system such that the remote participant may send a plurality of still images. While it is expected that only a portion of the area of the screen is designated for displaying one or two still images, many more may be present in the system's memory. Therefore, the user can access the images from memory by simply touching the frame around the still image (similar to grasping the margin of a page) for turning the page. The special purpose VideoPhone terminal then retrieves the next image from memory and displays it in place of the present image. Well-known graphical functions may be included which turns or flips the present page in an animated fashion similar to turning the real page of a book or album. Separate hotspots may be defined on the left and right margins for flipping forward and flipping backward, respectively. In addition, the frame might include a page number in a “page x of y” format that identifies the current image and the total number of images in memory.

Also, the user may select to view the image of the remote participant as a real-time motion image or as a still image. The user can switch from motion mode to still or “freeze” mode by touching the frame around the motion image. The last still image of the remote participant received by the system is continuously displayed, perhaps as a preview image to be printed. During freeze mode, the frame may contain indicia warning the user that the still mode has been selected and instruct the user how to restart the motion mode. Alternatively, the color of the frame may change from green to red indicating that the motion has been stopped.

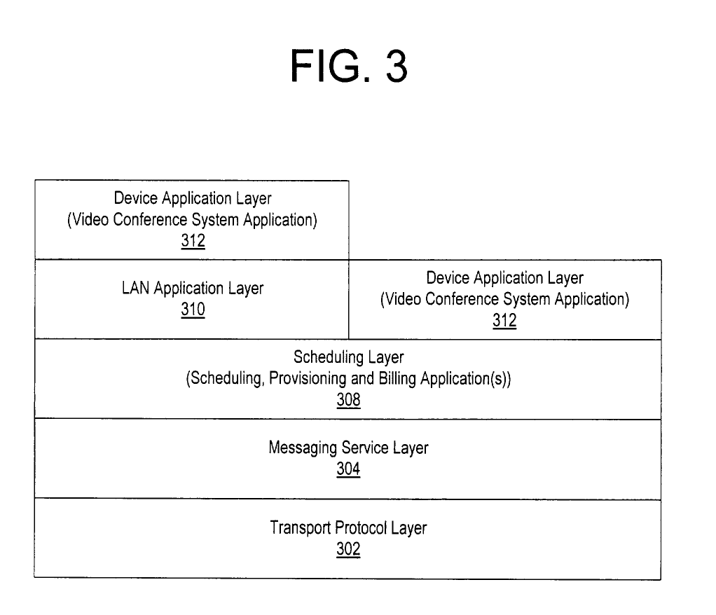

To that end, the present invention utilizes primarily off-the-shelf components in a layered approach for providing face-to-face video teleconferencing services in a manner which requires little or no proficiency in using teleconferencing applications. FIG. 3 is a diagram illustrating the layered structure of the applications used for implementing the present invention. Initially, it should be understood that it is expected that the present invention will be implemented in a WAN network such as the Internet. Therefore, the base layer is transport protocol layer 302 which is compliant with the WAN. The Internet uses a two-layered Transmission Control Protocol/Internet Protocol (TCP/IP) suite (similar to the seven-layered Open System Interconnection (OSI) suite) consisting of an application protocol layer, a TCP layer and an IP layer application protocol layer (often an application protocol layer is considered part of the TCP/IP suite). One of ordinary skill in the art would readily understand the inner workings of the TCP/IP protocol suite. The TCP layer assembles messages into smaller packets for transport over the Internet and reassembles these packets into the original message. The IP manages the address portion of each packet.

However, the TCP/IP protocols do not know or understand the language and format used in a user's client/server program. Therefore, an application layer is necessary to support various applications used over the Internet. The application delivers its data to the communications system by passing a stream of data bytes to the transport layer along with the socket of the destination machine. The present invention utilizes messaging service layer 304 which is H.323 compliant. H.323 is a standard approved by the International Telecommunication Union (ITU) for compatibility in videoconference transmissions over IP networks. It is expected that any one of a variety of videoconference (or messaging) applications that enables point-to-point telephony and VideoPhone capability over the Internet can be utilized for practicing the present invention. A point-to-point conference between two people is relatively simple and normally referred to as videophoning, while true videoconferencing normally denotes creating simultaneous conferences with more than a single site. For example, NetMeeting, a trademark of and available from Microsoft Corporation in Redmond, Wash.; CuseeMe, a trademark of and available from First Virtual Communications in Santa Clara, Calif.; and PictureTalk, a trademark of and available from Pixion, Inc. in Pleasanton, Calif., are all examples of true videoconference applications, while Intel® Video Phone from Intel Corporation in Santa Clara, Calif. is a VideoPhone application.

Next, the present invention utilizes scheduling layer 308 consisting of scheduling, provisioning and billing applications. The primary function of scheduling layer 308 is to provide the system with temporal management for provisioning a session based on usage and billing requirements. The scheduler accepts requests for VideoPhone sessions reservations; checks the requested time period of a session for a scheduling conflict; validates billing information with the billing application; logs the requested session into a schedule at the requested time period; confirms the scheduled time period with the recipient of the VideoPhone session and at the scheduled time period; and provisions the VideoPhone for bi-directional and real-time video and audio through the Internet. A session, for the purposes herein, may be created by one participant and joined by any number of other participants. While a session is often described as having at least two connecting parties, a single participant can initialize a session that may be joined by a second participant.

On top of scheduling layer 308 is device application layer 312 and LAN application layer 310 which is topped by device application layer 312. In the first case, a facility may utilize only a single special purpose VideoPhone so the scheduling application layer interacts directly with the device application layer 312 for controlling the special purpose VideoPhone, an example of which is terminal 160 in FIG. 1. With respect to the second case, scheduling application layer 308 interacts with device application layer 312 through a distributive network application 310 for routing and controlling multiple special purpose VideoPhone terminals at various node on a LAN. An example of the distributed mode is depicted by terminals 140 and 142 connected to LAN 106 depicted in FIG. 1.

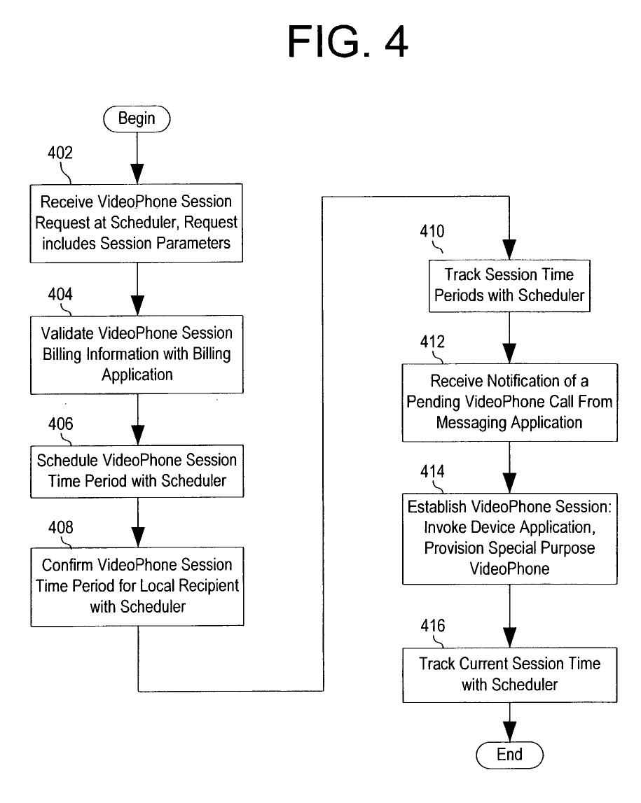

FIG. 4 illustrates a process for VideoPhone session handling in accordance with an exemplary embodiment of the present invention. The process begins with a participant requesting a VideoPhone session (step 402). The session request comprises all information necessary to validate a VideoPhone session such as the identities of the caller and the recipient and the requested session time and duration (time period). Additionally, the request may include billing authorization information and call setup parameters, such as the identity and version of the VideoPhone application (set up parameters are usually provided implicitly by the application itself in control packets when a VideoPhone session is established). The request may be initiated either locally at the special purpose VideoPhone terminal or remotely on any computer capable of establishing a VideoPhone session. However, the request need not be made through the VideoPhone application (or messaging application). Instead, a request may be made directly to the facility managing the special purpose VideoPhone terminal using an HTML request document available on the facility's home page via an http exchange. Alternatively, certain remote users may be authorized to request a session directly to the scheduler through, for example, a portal on the facility's home page, or at some other secure or unsecured site by its URL (Uniform Resource Locator).

Next, if the requester provides billing authorization information, then the billing application validates the information for the requested VideoPhone session (step 404). Here it should be remembered that if a remote requester does not authorize billing, then billing authorization must be provided by a recipient when the session time period is confirmed (see step 408 below). Next, the scheduler logs the requested session time period onto a tabular listing or schedule (step 406). It is expected that the majority of sessions will be requested by a remote participant and confirmed by a local participant. Therefore, in normal operation, the scheduler will merely reserve the block of time requested by entering the requested time period onto the tabular schedule. The schedule is then available for viewing on the VideoPhone screen any time other than during a VideoPhone session. Alternatively, or in addition, the scheduler may send an e-mail message to a remote recipient when a VideoPhone session is requested by a local participant. In either case, in accordance with one exemplary embodiment, the scheduler will require that the non-requesting participant confirm whether the requested session-time period is convenient (step 408). The local participant confirms the requested session period using the VideoPhone terminal, while a remote participant may confirm via return e-mail message or on a schedule presented on the facility's home page. The billing authorization parameters must be verified by the billing application prior to the scheduler accepting confirmation of the session time period. Therefore, if the billing parameters have not been verified by the billing application, the confirming participant must provide billing authorization information when confirming the VideoPhone session.

The scheduler continually tracks scheduled session time periods (step 410). Only when the current time is within a scheduled VideoPhone session time period will the scheduler allow a VideoPhone session to be established. Thus, any time other than during a scheduled VideoPhone session will the scheduler return an error to any VideoPhone application attempting to establish a session with the special purpose VideoPhone terminal. Additionally, each VideoPhone session must be confirmed by both participants prior to the scheduler provisioning the session, thus lessen instances where the VideoPhone terminal is unavailable because a session has been established with only one participant. However, once the time for a confirmed VideoPhone session occurs, the scheduler will accept notification messages from remote VideoPhone applications that a VideoPhone call is pending (step 412). Accepting the call establishes the session. However, the caller information (caller ID, recipient ID, etc.) is validated by the scheduler prior to invoking the device application for provisioning the special purpose VideoPhone terminal (step 414). After the session has been established and the local participant joins the session on the local VideoPhone terminal, the scheduler tracks the current session time and notifies the parties in advance of the expiration of the time period (step 416). Additionally, the billing application maintains a logical connection to the scheduler while the VideoPhone session is in progress and increments the charges at the billing rate during that session. Once the session terminates, the billing application compiles the charges for the session.

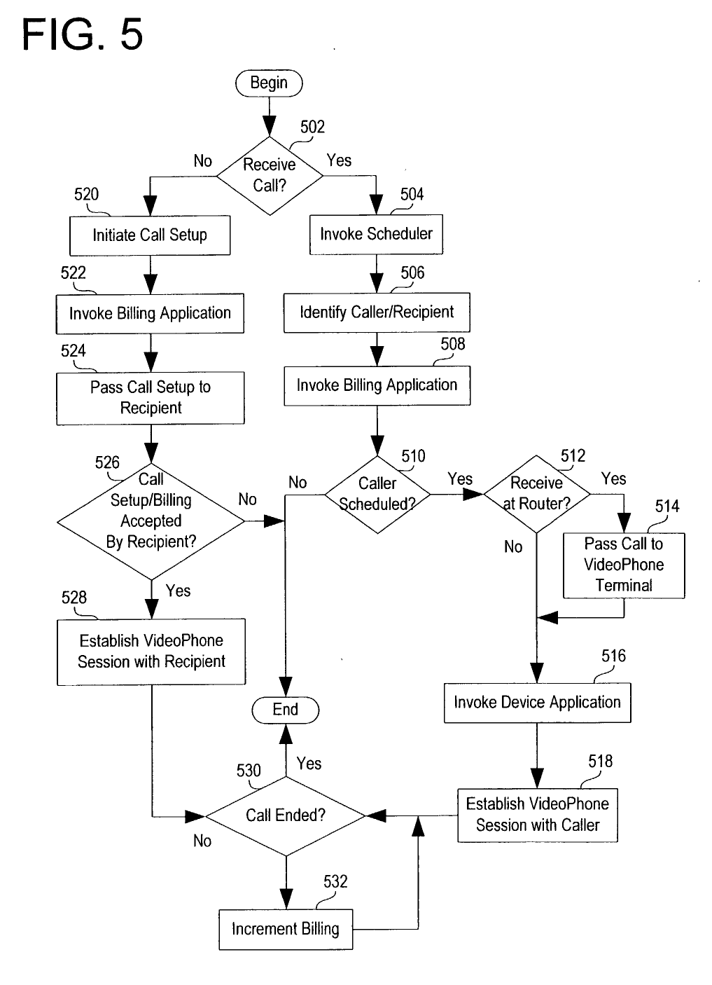

FIG. 5 illustrates a process for establishing a VideoPhone session where one of the terminals is a special purpose VideoPhone terminal in accordance with an exemplary embodiment of the present invention. Here it should be understood that the special purpose VideoPhone might initiate a session as well as join one. The process begins with a logical test for the type of call, incoming or outbound (step 402). If the session to be initiated is from an inbound call, the inbound call will be accepted only if the call session has been previously requested, scheduled and confirmed by both participants. Since those functions are generally attributed to the scheduler, the scheduler application is invoked (step 504). The caller and recipient are identified by the scheduler (step 506) and then the billing application is invoked (step 508). The billing application must be notified of a call prior to call setup in order to establish a logical connection to the scheduler when the call session.

Next, the call time slot matching the call information is checked (step 510). If the call has not been received within the confirmed time period reserved for the VideoPhone session, an error is returned to the caller and the call is dropped without establishing a session. Here is should be understood that the present system may accept a call on “hold” just prior the start of the session. This allows the caller to be on line while the recipient is not at the VideoPhone terminal. Any time after the start of the confirmed time period reserved for the VideoPhone session, the local participant may join the session (complete the connection) by merely picking up a hand set or selecting a predefined hotspot on the screen for completing the connection.

Returning to step 510, if the scheduler determines that the VideoPhone session is scheduled, then it must be determined whether or not the call has been received at a boundary router for a local LAN (step 512). The layered architecture depicted in FIG. 3 may be implemented in a variety of disparate variants. In accordance with one embodiment, the entire layered structure of the applications used for implementing the present invention are resident in a local client, such as client 150 depicted in FIG. 1. Alternatively, a remote application server may provide application support such as for special purpose terminals 140 and 142 connected to LAN 106, also depicted in FIG. 1. In the latter case, the scheduling, provisioning, billing and possibly device applications are resident in a central remote application server which acts as a special purpose VideoPhone terminal, firewall and service center where all VideoPhone processes are executed. The call data, video and audio, must still be routed to the correct VideoPhone terminal (step 514), but only after passing through the layer application architecture in the server as described herein.

At this stage, the device application is invoked (step 516). As a practical matter, the device application is always running, e.g. displaying VideoPhone scheduling information, current time, date and temperature, special events and other useful data. However, the VideoPhone features of the special purpose VideoPhone terminal are locked until a session is processed through the scheduler and billing application as described above. At this point, the VideoPhone session is established and joined by the user who picks up the telephone handset or interacting with a hotspot on the touch screen for connecting the caller (step 518). The scheduling and messaging applications continually check to see that the VideoPhone session is valid, i.e. the parties are connected and the session does not extend into another confirmed scheduled VideoPhone time period (step 530). During the VideoPhone session, the billing application continually increments the billing amount (step 532); however, once the session ends, the logical connection to the billing application is broken, the billing finalized and the call ended.

Returning now to step 502, if the VideoPhone session is initiated at the special purpose VideoPhone terminal, call setup is initiated through a conventional process (step 520). For instance, the identity of the recipient, the recipient's network address, and other call data is requested from the caller. The billing application is invoked and billing authorization information is requested from the caller (step 522). Of course, the present billing application is flexible enough to allow the caller to request that a VideoPhone session be billed to the recipient, i.e. a collect VideoPhone session. The call setup information is then passed to the recipient's network address, along with any billing requests or other information necessary to establish a VideoPhone session (step 524). The recipient must then respond to the VideoPhone session request by accepting the session parameters and billing requirements (step 526). If the recipient does not affirm the request within a predetermined time period, the call ends, either by declining the call or because the call request times out. At this point, the VideoPhone session is established and a connection is completed by the recipient affirming the request for a VideoPhone session (step 528). Again, the scheduling and messaging applications continually check to see that the VideoPhone session valid (step 530). The session continues until either the scheduling application or the messaging application detects that the VideoPhone session is not valid. During the VideoPhone session, the billing application continually increments the billing amount (step 532); however, once the session ends, the logical connection to the billing application is broken, the billing finalized and the call ended. Alternatively, the billing application can autonomously end the session by disconnecting the logical connection to the scheduler which happens in cases where the billing participant has authorized a predetermined billing limit for the session. Once the limit has been reached, the billing application disconnects the logical connection and the call is dropped. The VideoPhone session cannot be reestablished until the parties reconnect through the layered application process.

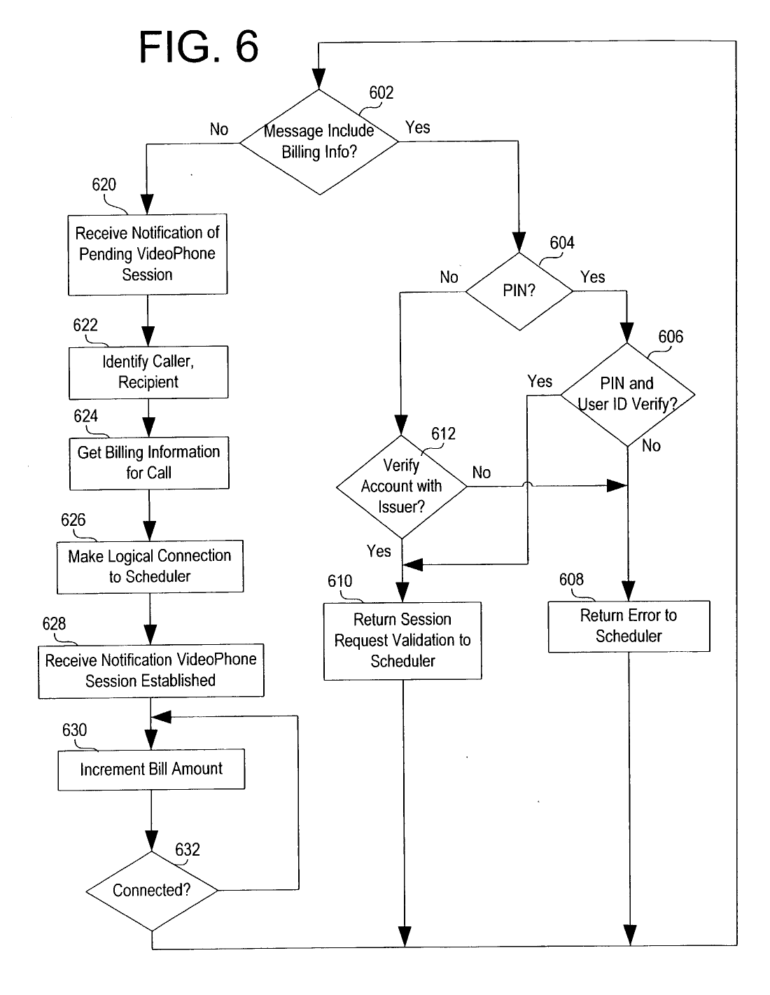

Turning to FIG. 6, a flowchart depicting a billing process implemented by the billing application in accordance with an exemplary embodiment of the present invention is illustrated. It is expected that the billing application is continually running in the background, thus the present flowchart depicts a process loop that is initiated with the receipt of a message. In accordance with the layered application approach depicted in FIG. 3, the message should be routed through the scheduling application, but other message paths are also possible. The billing application has two primary functions: validates billing information; and forms a logical connection with the scheduler during a session for determining billing charges to a participant during the session. Therefore, any message received by the billing application is checked first for content (step 602).

The message may include session information or billing authorization information. If the message includes a billing authorization, the billing information may be in one of two forms: direct charge or deferred charge. Direct charge information includes credit card, debit card or other payment account information, while deferred charge information relates to a user account that has been previously established with the billing application and includes account identity information that is recognizable by the billing application. Therefore, the message content is checked for a user Personal Identification Number (PIN) (step 604). If a PIN is contained within the message, the user's identity and the PIN are checked in a secure, internal account database (step 606). If the user ID and PIN do not verify, an error is returned to the scheduler and a logical connection cannot be formed (step 608). The billing application then returns to the background state. If the PIN and user ID are verified, the session request is authorized by the billing application; thus, the scheduler can allow the requested time period to be confirmed by the parties (step 610).

Returning to step 604, if a PIN is not contained within the message, then the billing application must verify a valid credit or debit card account for the participant (step 612). If the card information cannot be validated by the card's issuer, an error is returned to the scheduler and therefore a logical connection cannot be formed between the scheduler and the billing application (step 608). The billing application then returns to the background state. If, on the other hand, the issuer of the user's card verifies the card information, the session request is authorized by the billing application and the scheduler can allow the requested time period to be confirmed by the parties (step 610).

As noted above, the billing application performs two primary functions: verifies account information and tracks billing charges. Returning to step 602, if the message from the scheduling application includes a notification that a VideoPhone session is pending (step 620), the call, caller and recipient are identified from the information (step 622) and the identity information is used to retrieve the billing information for the session (step 624). Next, the billing application makes a logical connection to the scheduling application for the session. Generally, the logical connection is a secure path for transmitting call and billing information between applications. The logical connection may allow for a bi-directional data stream between the applications. Essentially, the existence of the logical connection signifies that charges are being incremented by the billing application to the participant's account that authorized the payment. When the VideoPhone session is dropped, for whatever reason, the logical connection is broken and the billing application ceases to accumulate charges. In accordance with other embodiments, the logical connection for the call remains intact during call setup and call hold periods, but receives notification of the call status from the VideoPhone application (messaging application) and accumulates the billing charges accordingly. If a session is unexpectedly interrupted, the logical billing connection remains unbroken for a time and billing is continued if another VideoPhone session is established between the participants.

When the scheduler senses that the logical connection is made, the session can then be established and the billing application receives notification (step 628). Charges are continually incremented (step 630) until the connection is lost when the billing application returns to background state (step 632).

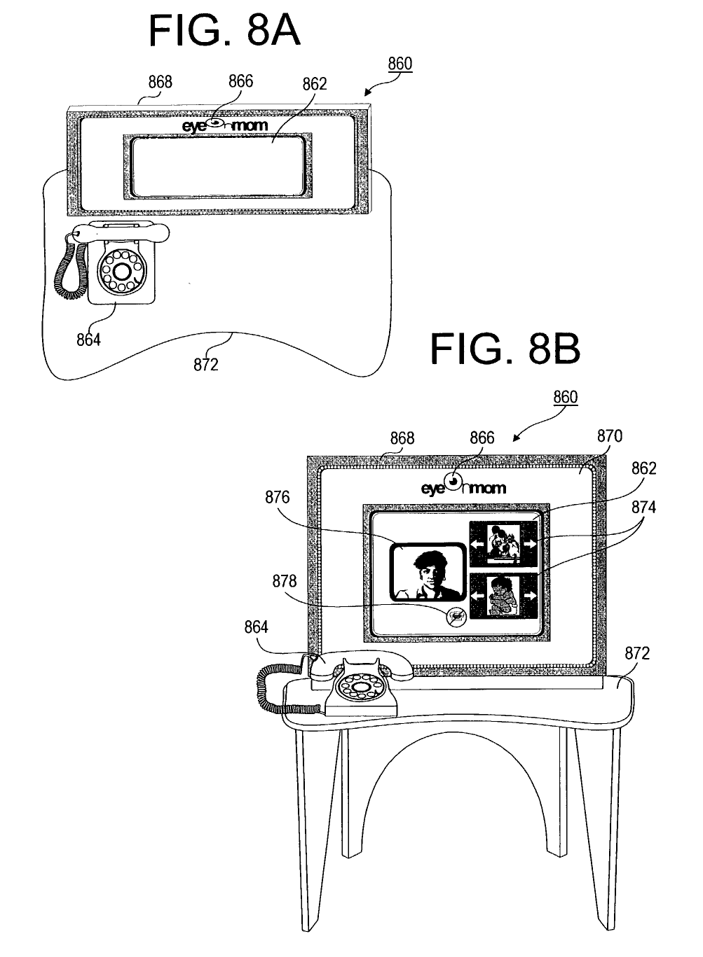

The present invention enables participants to engage in face-to-face videophoning even though one or both parties may not be familiar with personal computers or videoconference equipment by arranging a special purpose VideoPhone terminal as more familiar equipment. FIGS. 8A and 8B are top and front views of a special purpose VideoPhone in accordance with an exemplary embodiment of the present invention. Special purpose VideoPhone terminal 860 provides the user with a familiar, unobtrusive and non-threatening terminal which is specifically designed for its soothing appeal to the user. Any component that may intimidate the user has been eliminated from terminal 860 or hidden from the user's eyesight. Essentially, VideoPhone terminal 860 comprises three physical structures: desk 872, telephone 864 and display 868. Desk 872 is specially designed to accommodate users that may be confined to a wheelchair or need extra leg room for some other reason. Additionally, desk 872 conforms to the Americans with Disability Act (ADA) and state accessibility standards. Telephone 864 may be a conventional analog telephone that is digitally converted for VideoPhone sessions. Touch-tone buttons on telephone 864 may be used for sending DTMF tones to the device application as well as to the hook switch. In accordance with on exemplary embodiment of the present invention, telephone 864 is disguised as a less menacing-looking telephone. It is expected that VideoPhone terminal 860 will be extensively used by older persons, and in those cases, a particularly suitable design is one reminiscent of the telephones commonly used when the users were younger and give a nostalgic impression to the user. Thus, for those situations, telephones with contemporary or ultra-modern designs would be unsuitable as would ear-piece/headset combinations and the type of portable headsets that are often used and associated with computers. In any case, telephone 864 should be an uncomplicated device that is easy to use and unthreatening to a user.

Display 868 comprises touch screen display 862 and hidden video camera 866 recessed within frame 870 of display 868. In accordance with one exemplary embodiment of the present invention, frame 870 is designed to be as unobtrusive as possible and may take the physical appearance of a frame on a television set, a picture frame, shadowbox or the like. Furthermore, frame 870 may be of a color, shading, pattern and/or texture that is not suggestive of a conventional video screen but instead is more indicative of the frame surrounding a painting or a television set. The intent of display 868 is to be as innocuous as possible and not to threaten session participants by presenting a conventional VideoPhone apparatus or computer system. Frame 870 may also be decorated with calming patterns and colors which subdue the sensation that the participant is partaking in a high technology experience. The color and patterns on frame 870 may also be used to hide or disguise camera 866 from the participant, thereby reinforcing the feeling of calm within the participant by not overtly subjecting the participant to the experience that her every more is being captured on camera. Notice that in the depicted example, camera 866 is disposed within the frame and disguised as the “O” in the “eyeOnmom” logo. Alternatively, camera 866 is apparently disposed within touch screen display 862 by increasing the area of the faceplate protecting screen display 862 and mounting camera 866 behind the faceplate but not within the useful display surface area of touch screen display 862. It should be appreciated that camera 866 may not contain the electronic components necessary for capturing an image, but may be implemented as a fiberoptic lens such as the ProbeCam available from Sandpiper Technologies, Inc. in Manteca, Calif. In that case, the visible area of camera 866, including the lens, might be reduced. In accordance with one exemplary embodiment of the present invention, display 868 is supported and/or secured on desk 872 with display supports (not shown). In accordance with other exemplary embodiments of the present invention, display 868 and telephone 864 are used apart from desk 872 and therefore the supports for display 868 need not conform to the structure desk 868 in any way.

A VideoPhone session participant views a real-time motion image of the remote participant on what appears to be a television screen but is actually touch screen 862. The user may interact with the VideoPhone system using the touch-tone buttons on telephone 864 or using predefined hotspots on television-like screen 862. Screen 862 is subdivided into separate frames for still and motion images. In FIG. 8B, those hotspots can be seen as corresponding with real-time motion image 876, still images 874 and graphic image 878. Real-time motion image 876, still images 874 and graphic image 878 are examples of user interaction hotspots that are present only during an active VideoPhone session. Real-time motion image 876 is a frame for the real-time motion image of the remote participant, while still images 874 are frames of still images that have been transmitted to VideoPhone terminal 860 by the remote participant. At any point during the VideoPhone session, the user can create a hard copy print of either the remote participant or an image in any other frame by merely touching the hotspot associated with the desired image.

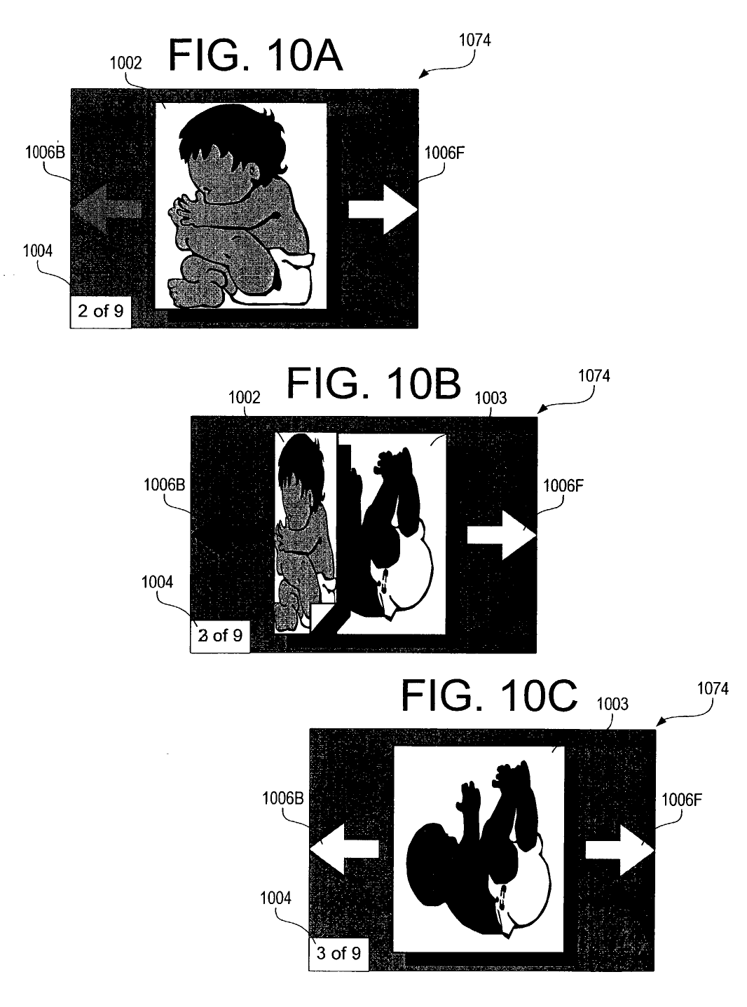

Sufficient memory is provided in, or associated with, VideoPhone terminal 860 such that a plurality of still images may be stored for sequential viewing. Additional functional hotspots on screen 862 allow the user the capability to flip through images by merely touching a hotspot associated with flip functionality. The user accesses the images from memory by simply touching the frame around still image 874, similar to grasping the margin of a page to turn the page. VideoPhone terminal 860 retrieves the next image from memory and displays it in place of the present image. This feature is more clearly shown in FIGS. 10A-10C. Notice that each of image frames 1074 comprise images 1002/3, counter 1004 and forward flip arrow 1006F and back flip arrow 1006B. In the depicted image sequence, a user has selected back flip arrow 1006B in FIG. 10A which initiates the back image flip function of VideoPhone terminal 860. As the sequence progresses in FIG. 10B, image 1002 is flipped (turned) in the direction of back flip arrow 1006B, thereby partially exposing the next image displayed from memory, image 1003. Notice also that counter 1004 has begun to change from “2 of 9” to “3 of 9.” Finally, FIG. 10B illustrates the complete flip where image 1002 is fully turned and image 1003 is completely visible. Counter 1004 now reads “3 of 9” identifying image 1003 as the third of nine images in memory.

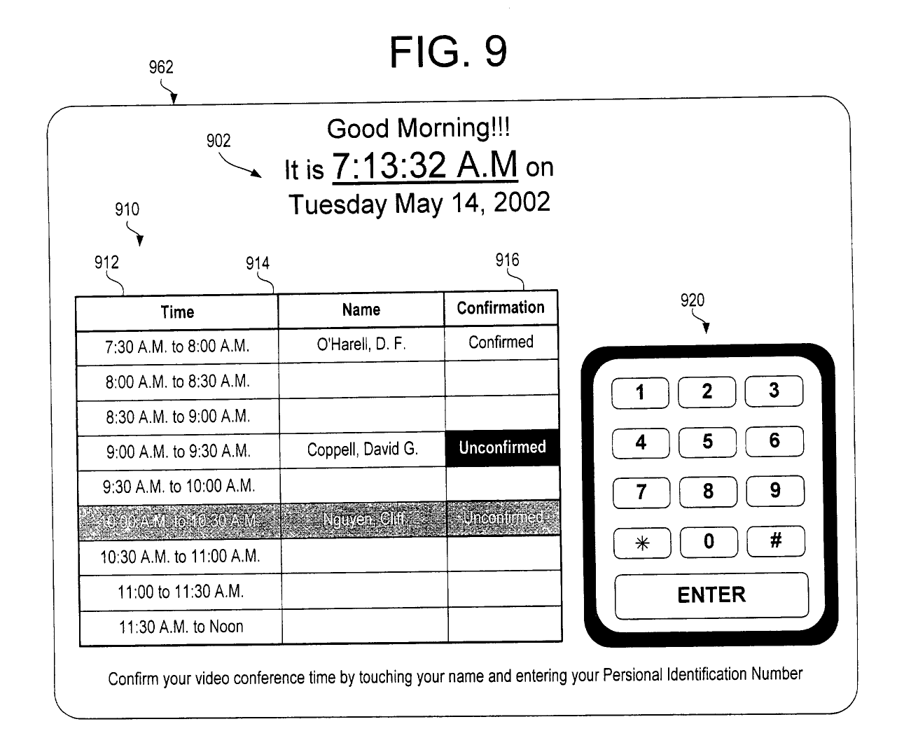

However, it is expected that whenever special purpose VideoPhone terminal 860 is not in use, screen 862 will display a tabular listing of scheduled VideoPhone sessions. FIG. 9 is a diagram of a screen display when a session is not active in accordance with an exemplary embodiment of the present invention. When a VideoPhone session is not in operation, screen 962 will generally be used for displaying temporal and topical information 902. Information content is not associated with any VideoPhone functionality, therefore no active areas are defined for portions of screen 962 where information is being displayed. However, screen 862 may also display VideoPhone schedule 910 as a tabular listing. Schedule 910 may be subdivided by entry type, such as time 912, one or more participants' name 914, and session confirmation indication 916. Schedule 910 might be displayed merely as a passive display or alternatively, active areas may be defined for session entries. With respect to the latter case, a user may select a scheduled session merely by touching any portion of the session entry in schedule 910. In the depicted example, the user has selected the VideoPhone session scheduled for time period “10:00 A.M. to 10:30 A.M.” If user Nguyen has selected that session, he may change the confirmation indication from “unconfirmed” to “confirmed” merely by entering his user PIN.

Whenever a VideoPhone session is not active, touch-pad graphic 920 may also be displayed for entry of the user PIN. The user merely touches the desired graphical numbers and touch-pad graphic 920 echoes the interaction by emitting an audible tone. Alternatively, DTMF tones from telephone 864 (FIGS. 8A and 8B) may also be used to enter private information such as a user-ID or PIN for scheduling or accepting a VideoPhone session.

Additionally, during a VideoPhone session, VideoPhone terminal 860 may be provided with stop-motion (or freeze) functionality allowing the user to view real-time motion image 876 or freeze the image. The user can freeze the motion image by touching a hotspot associated with the frame around motion image 876. The most recent image of the remote participant is frozen in frame 876. Indicia may also be displayed during the freeze mode indicating that still mode has been activated and instructs the user that the motion mode may be restarted by touching the frame.

In accordance with some exemplary embodiments of the present invention, the local user may interact with the special purpose VideoPhone terminal using a variety of mechanisms, such as for example, a standard mouse, keyboard or touch-pad, telephone touch-tone buttons and hook-switch, or touch screen display, such as screen 862 in FIG. 8. By using a touch screen display, the user may be presented with an interaction interface that is versatile, simple to understand, easy to use and, when represented as an ordinary television, is neither obtrusive nor intimidating to the user. Additionally, when the special purpose VideoPhone terminal is configured with a touch screen display, the display can provide a separate set of functions for a VideoPhone session and for standby.

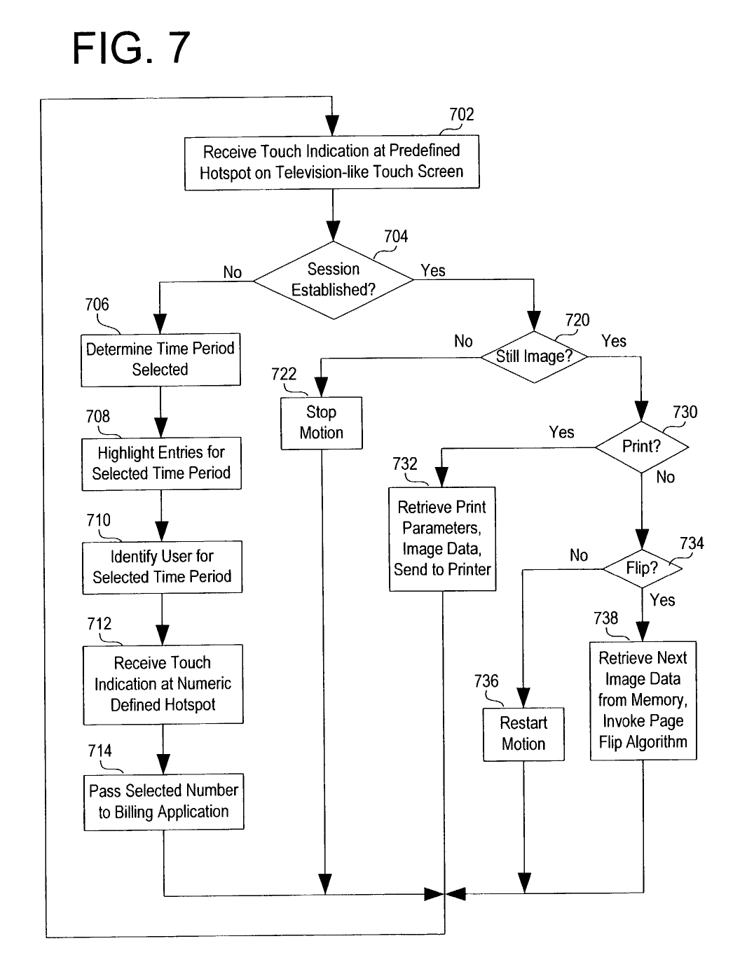

FIG. 7 is a flowchart of a process implemented by the device application for processing user interactions in accordance with an exemplary embodiment of the present invention. It is expected that the device application is continually running in the background and monitoring the condition of the touch screen, thus the present flowchart depicts a process loop that is initiated with the receipt of a touch indication in a predefined hotspot on the screen (step 702). As noted above, certain features supported by the device application are active only when a session is current, while other features are active when a session is not taking place. Therefore, certain hotspot areas on the screen correspond to active sessions, while others correspond to inactive sessions (step 704). When a VideoPhone session is not currently active, touch indications to screen 862 correspond to session time period on schedule 910, thus the scheduled session is identified by the device application (step 706). In quick succession, the device application echoes the selection by highlighting the scheduled entries corresponding to the selected session (step 708) and internally identifies the participants for the session (step 710). Once the user recognizes that the proper session has been selected, the user's secret PIN is entered on touch-pad graphic 920, which echoes the interaction by emitting an audible tone (step 712). Of course, the PIN may also be entered on the keypad of telephone 864. Finally, the device application passes the numeric selections to the billing and/or scheduling applications (step 714).

Returning to step 704, if a VideoPhone session is currently in progress, real-time motion image 876, still images 874 and graphic image 878 are presented on screen 862 as depicted in FIG. 8B. Normally, any interaction, other than leaving the VideoPhone session, from this point forward will be with one or more of the images being displayed. The user may leave the session by touching graphic image 878 (not depicted in FIG. 7). When the device application receives a touch indication during a session, it first determines whether the image being touched is a still image (step 720). If not a still image, motion image 876 has been selected. Ordinarily, it is not desirable to print from a motion image; therefore, the device application provides functionality to freeze a motion image for print preview whenever it receives a touch indication (step 722). The device application then returns to background mode.

Returning to step 720, a still image might be one of images 874 or motion imager 876 in “freeze” mode. Therefore, any of the still images can be printed to a hard copy. A determination is made as to whether the touch indication is on an area of the image designated for printing (step 730). For ease of use, the entire image may be predefined in the device application as a print hotspot. Thus, if any image is still, merely touching it will result in a print being generated from the image. Therefore, in response to touching a still image, the device application retrieves the print parameters from memory, accesses the image data and sends that image data to the printer (step 732). The device application then returns to background mode.

Returning to step 730, if the touch indication is not on the image area, then the common command is directed to an image motion, i.e. either a flip or unfreeze function. Flips are possible only with still images 874, assuming other images are in memory. If the interaction is directed at motion image 876 and is not a PRINT command, then the interaction is interpreted by the device application as an UNFREEZE command and image 876 is returned to motion (step 736). The device application then returns to background mode.

If, on the other hand, the user interaction is directed to images 874 and is not a PRINT interaction, then the interaction is interpreted by the device application as a FLIP command. In that case, the device application replaces the present image by another image in memory as described above with respect to FIGS. 10A-10C. From there, the device application then returns to background mode.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application and to enable others of ordinary skill in the art to understand the invention for various embodiments with various modifications as are suited to the particular use contemplated.

What is claimed is:

1. A special purpose VideoPhone apparatus for facilitating face-to-face videoconference sessions comprising:
a data processor comprising;
memory;
a video processing means;
an audio processing means; and
an audio and video data transmission means, said audio and video data transmission means coupled to said video processing means and further coupled to said audio processing means;
an unobtrusive display comprising:
a video screen, said video screen coupled to video processing means in said data processor;
a frame, said frame bordering at least a portion of said video screen; and
a support means for supporting said display.
a video capture means, said video camera coupled with to video processing means in said data processor and said video capture means further being partially hidden in said unobtrusive display; and
a telephone handset, said telephone handset coupled to said audio processing means in said data processor.

2. The apparatus recited in claim 1 above, further comprising:
a desk, said desk supporting said display.

3. The apparatus recited in claim 2 above, wherein said desk substantially conforming to the Americans with Disability Act (ADA).

4. The apparatus recited in claim 1 above, further comprising:
a printer, said printer coupled to said data processor.

5. The apparatus recited in claim 1 above, wherein said unobtrusive display being fashioned as a conventional television set.

6. The apparatus recited in claim 1 above, wherein said video screen further comprising:
a touch screen, said touch screen coupled to said data processor for receiving a tactile input and communicating the tactile input.

7. The apparatus recited in claim 1 above further comprises:
a scheduler, said scheduler being executed on said data processing system for arbitrating videoconference sessions between users.

8. The apparatus recited in claim 7 above, wherein said scheduler further comprises:
a schedule displayer, said schedule displayer being executed on one of said data processing system and said video means for displaying a schedule of videoconference sessions.

9. The apparatus recited in claim 8 further comprises:
a biller, said biller being executed on said data processing system for billing a user for a session.

10. The apparatus recited in claim 1 above, wherein said video processing means further comprises:
simultaneous still video processing and motion video processing means.

11. The apparatus recited in claim 1 further comprises:
a biller, said biller being executed on said data processing system for billing a user for a session.

12. The apparatus recited in claim 1 above, wherein said video screen further comprising:
a touch screen, said touch screen coupled to said data processor for receiving a tactile input and communicating the tactile input.

13. The apparatus recited in claim 9 above, wherein said biller further comprises:
a schedule displayer, said schedule displayer executed on one of said data processing system and said video means for displaying a schedule of videoconference sessions.

14. An method for facilitating face-to-face videoconference sessions on a special purpose VideoPhone apparatus comprising:
receiving transmission data at a special purpose VideoPhone apparatus, said special purpose VideoPhone apparatus comprising:
a data processor comprising;
memory;
a video processing means;
an audio processing means; and
an audio and video data transmission means, said audio and video data transmission means coupled to said video processing means and further coupled to said audio processing means;
an unobtrusive display comprising:
a video screen, said video screen coupled to video processing means in said data processor;
a frame, said frame bordering at least a portion of said video screen; and
a support means for supporting said display.
a video capture means, said video camera coupled to video processing means in said data processor and said video capture means further being partially hidden in said unobtrusive display; and
a telephone handset, said telephone handset coupled to said audio processing means in said data processor;
parsing the transmission into video data and audio data;
displaying the video data as a motion image on said video screen; and
outputting the audio data as audio on said telephone handset.

15. An method recited in claim 14 above further comprises:
separating the video data into motion video data and still video data;
displaying the motion video data as a motion image on said video screen; and
displaying the still video data as a still image said video screen simultaneous with the motion image on said video screen.

16. An method recited in claim 15 above further comprises:
receiving an interaction from said user; and
altering one of said motion image and said still image on said video screen in response to said interaction.

17. An method recited in claim 14 above further comprises:
receiving a request for a videoconference session from a requester, wherein said request includes one of videoconference session time, videoconference session time period, and requester identification;
logging the requested videoconference session onto a session list; and
displaying the session list on a tabular scheduling videoconference session on said video screen.

18. An method recited in claim 17 above further comprises:
receiving a confirmation for a videoconference session from an invitee, wherein said confirmation includes one of videoconference session time, videoconference session time period, and requester identification;
identifying a video session on said videoconference session list;
holding the requested videoconference session onto said session list; and
authorizing one of the requestor and invitee to join videoconference session.
